(19) United States
(12) Patent Application Publication
(10) Pub. No.: US 2023/0373750 A1
(43) Pub. Date: Nov. 23, 2023

(54) ELEVATOR COMMUNICATION SYSTEM, A METHOD AND AN APPARATUS

(71) Applicant: KONE CORPORATION, Helsinki (FI)

(72) Inventors: Ari Kattainen, Helsinki (FI); Juha-Matti Aitamurto, Helsinki (FI)

(73) Assignee: KONE CORPORATION, Helsinki (FI)

(21) Appl. No.: 18/228,345

(22) Filed: Jul. 31, 2023

Related U.S. Application Data
(63) Continuation of application No. PCT/EP2021/052325, filed on Feb. 1, 2021.

(51) Int. Cl. B66B 1/34; B66B 5/00; B66B 13/14; B66B 3/00

(52) U.S. Cl. CPC B66B 1/3461; B66B 5/0031; B66B 13/146; B66B 1/3453; B66B 3/002

(57) ABSTRACT

An elevator communication system includes an elevator communication network configured to carry elevator system associated data; a plurality of elevator system nodes communicatively connected to the elevator communication network, wherein at least some of the plurality of elevator system nodes each includes a camera associated with at least one of an elevator car configured to provide image data indicating whether a car door of the elevator car is open or closed and a landing floor configured to provide image data indicating whether a landing door of the landing floor is open or closed; an elevator car; and an apparatus communicatively connected to the elevator communication network and being configured to obtain image data from the camera during an evacuation situation; and provide, during the evacuation situation, to a node communicatively connected to the elevator communication network, the image data to enable the node to verify based on the image data that the car door and/or the landing door is closed before the elevator car is moved during the evacuation situation.

### TECHNICAL FIELD

The present application relates to the field of elevator communication systems.

### BACKGROUND

In modern elevator system, elevators can be controlled efficiently to transport passenger between floors in a building. In evacuation situations, elevators may be used in the evacuation, and they may be operated in a special mode. However, when using the elevators for evacuating people during the evacuation situation, it has to be ensured that it is safe for the elevator car to move in an elevator shaft. For example, it may happen that a landing door at a landing floor may be wholly or partially open and this may expose the people at the landing floor to a danger.

### SUMMARY

According to a first aspect, there is provided an elevator communication system comprising an elevator communication network configured to carry elevator system associated data, a plurality of elevator system nodes communicatively connected to the elevator communication network, wherein at least some of the plurality of elevator system nodes each comprises a camera associated with at least one of an elevator car configured to provide image data indicating whether a car door of the elevator car is open or closed and a landing floor configured to provide image data indicating whether a landing door of the landing floor is open or closed, an elevator car, and an apparatus communicatively connected to the elevator communication network and being configured to obtain image data from the camera during an evacuation situation and provide, during the evacuation situation, to a node communicatively connected to the elevator communication network, the image data to enable the node to verify based on the image data that the car door and/or the landing door is closed before the elevator car is moved during the evacuation situation.

In an implementation form of the first aspect, the image data provided by the camera at least partially covers the car door or the landing door.

In an implementation form of the first aspect, the camera is integrated into a landing floor display.

In an implementation form of the first aspect, the camera is positioned above the car door.

In an implementation form of the first aspect, the image data comprises a time stamp enabling verification of the validity of the image data at the node.

In an implementation form of the first aspect, the plurality of elevator system nodes comprise a floor control board associated with the landing floor configured to provide floor information to be associated with the image data.

In an implementation form of the first aspect, the apparatus is configured to receive a verification request from the node to distinguish the elevator car among a plurality of elevators cars; and cause generation of a response action in response to the verification request.

In an implementation form of the first aspect, the node comprises a node internal to the elevator communication system.

In an implementation form of the first aspect, the node comprises a display arranged in an elevator car.

In an implementation form of the first aspect, the node comprises a remote node external to the elevator communication system.

In an implementation form of the first aspect, the elevator communication network comprises at least one point-to-point ethernet network.

In an implementation form of the first aspect, the elevator communication network comprises at least one multi-drop ethernet segment.

According to a second aspect, there is provided a method comprising: obtaining, by an apparatus connected to an elevator communication network, image data during an evacuation situation from a camera being communicatively connected to the elevator communication network and associated with at least one of an elevator car configured to provide image data indicating whether a car door of the elevator car is open or closed and a landing floor configured to provide image data indicating whether a landing door of the landing floor is open or closed; and providing, by the apparatus, during the evacuation situation to a node communicatively connected to the elevator communication network the image data to enable the node to verify based on the image data that the car door and/or the landing door is closed before the elevator car is moved during the evacuation situation.

In an implementation form of the second aspect, the image data provided by the camera at least partially covers the car door or the landing door.

In an implementation form of the second aspect, the camera is integrated into a landing floor display.

In an implementation form of the second aspect, the camera is positioned above the car door.

In an implementation form of the second aspect, the image data comprises a time stamp enabling verification of the validity of the image data at the node.

In an implementation form of the second aspect, the plurality of elevator system nodes comprise a floor control board associated with the landing floor configured to provide floor information to be associated with the image data.

In an implementation form of the second aspect, the method further comprises receiving, by the apparatus, a verification request from the node to distinguish the elevator car among a plurality of elevators cars; and causing, by the apparatus, generation of a response action in response to the verification request.

In an implementation form of the second aspect, the node comprises a node internal to the elevator communication system.

In an implementation form of the second aspect, the node comprises a display arranged in an elevator car.

In an implementation form of the second aspect, the node comprises a remote node external to the elevator communication system.

In an implementation form of the second aspect, the elevator communication network comprises at least one point-to-point ethernet network.

In an implementation form of the second aspect, the elevator communication network comprises at least one multi-drop ethernet segment.

According to a third aspect, there is provided an elevator system comprising an elevator communication system of the first aspect.

According to a fourth aspect, there is provided an apparatus connected to an elevator communication network. The apparatus comprises means for obtaining image data during an evacuation situation from a camera being communicatively connected to the elevator communication network and associated with at least one of an elevator car configured to provide image data indicating whether a car door of the elevator car is open or closed and a landing floor configured to provide image data indicating whether a landing door of the landing floor is open or closed; and means for providing during the evacuation situation to a node communicatively connected to the elevator communication network the image data to enable the node to verify based on the image data that the car door and/or the landing door is closed before moving the elevator car during the evacuation situation.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1A illustrates an elevator communication system according to an example embodiment.

FIG. 1B illustrates an elevator communication system according to another example embodiment.

FIG. 1C illustrates an elevator communication system according to another example embodiment.

FIG. 1D illustrates an elevator communication system according to another example embodiment.

FIG. 2 illustrates an apparatus associated with an elevator communication system according to an embodiment.

FIG. 3 illustrates a method according to an example embodiment.

FIG. 4A illustrates landing floors where a camera has been arranged at each floor according to an example embodiment.

FIG. 4B illustrates a landing floor where a camera has been arranged according to an example embodiment.

FIG. 4C illustrates a landing floor where a camera has been arranged according to an another example embodiment.

### DETAILED DESCRIPTION

The following description illustrates an elevator communication system that comprises an elevator communication network configured to carry elevator system associated data, a plurality of elevator system nodes communicatively connected to the elevator communication network, wherein at least some of the plurality of elevator system nodes each comprises a camera associated with at least one of an elevator car configured to provide image data indicating whether a car door of the elevator car is open or closed and a landing floor configured to provide image data indicating whether a landing door of the landing floor is open or closed, an elevator car, and a controller communicatively connected to the elevator communication network and being configured to obtain image data from the camera during an evacuation situation and provide, during the evacuation situation, to a node communicatively connected to the elevator communication network, the image data to enable the node to verify based on the image data that the car door and/or the landing door is closed before the elevator car is moved during the evacuation situation. The illustrated solution may enable, for example, a solution in which in an evacuation situation an operator operating an elevator car is able to ensure that car doors and/or landing doors are closed thus enabling safe travel for the elevator car in an elevator shaft.

In an example embodiment, the various embodiments discussed below may be used in an elevator system comprising an elevator that is suitable and may be used for transferring passengers between landing floors of a building in response to service requests. In another example embodiment, the various embodiments discussed below may be used in an elevator system comprising an elevator that is suitable and may be used for automated transferring of passengers between landings in response to service requests.

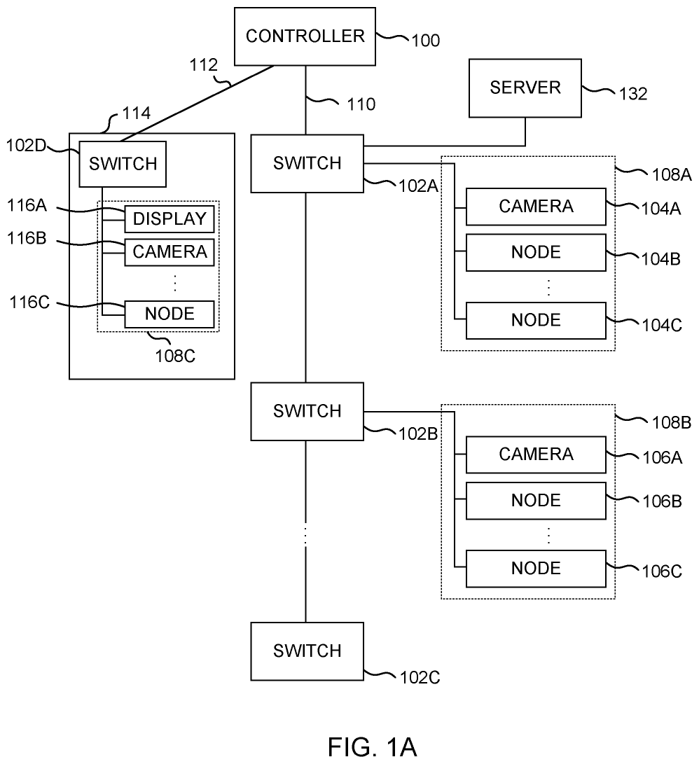

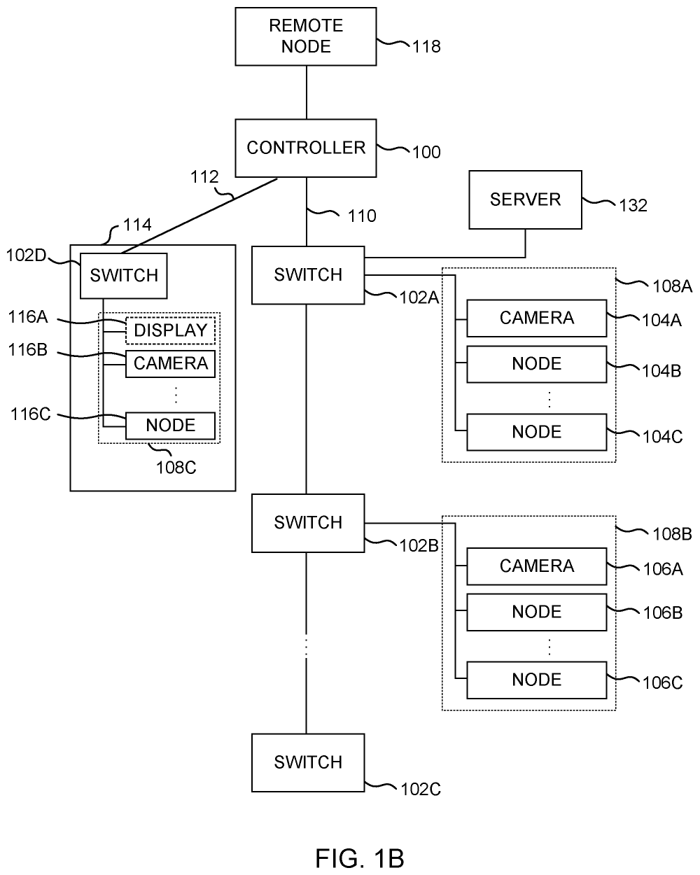

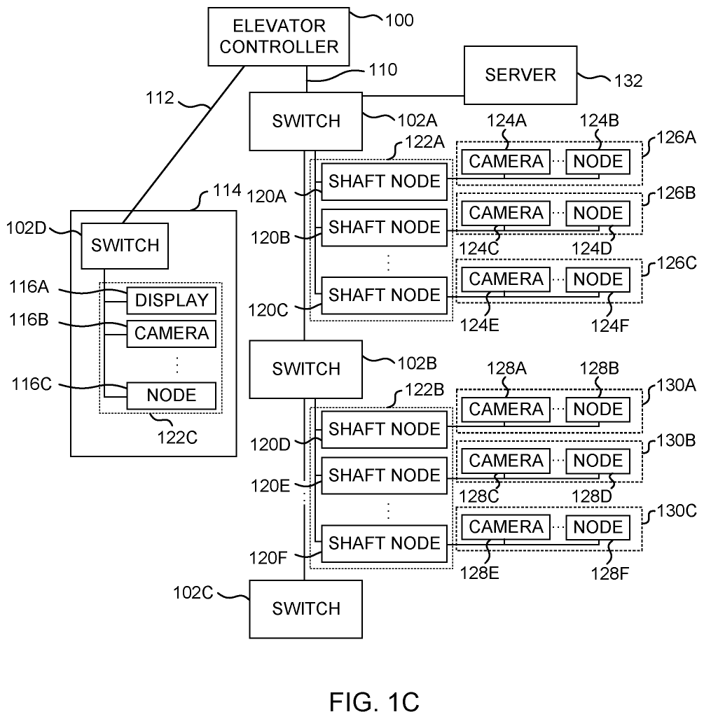

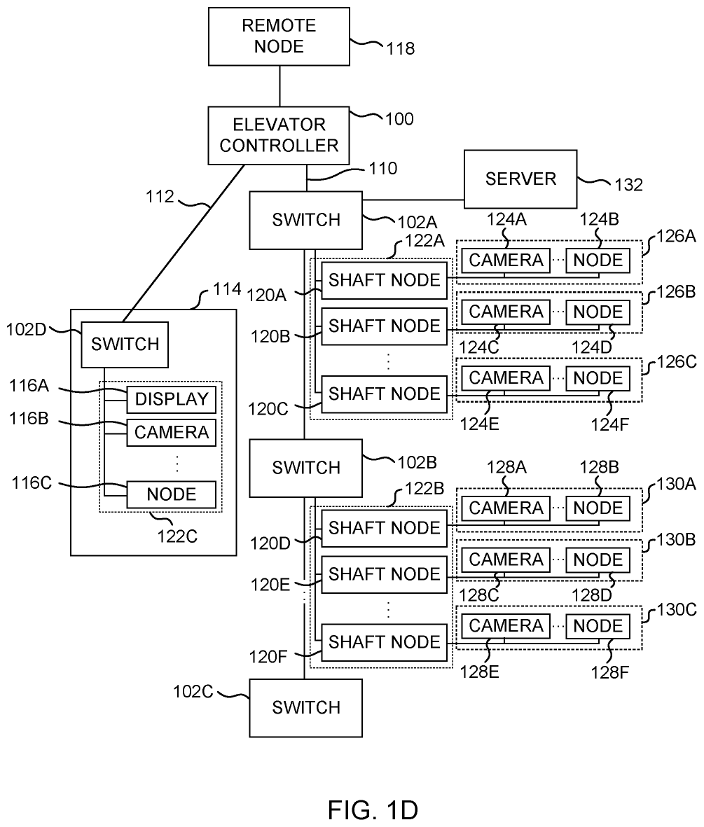

FIG. 1A illustrates an elevator communication system according to an example embodiment. The elevator communication system may comprise a controller 100. The elevator communication system further comprises an elevator communication network configured to carry elevator system associated data. The elevator communication network may be an ethernet-based communication network and it may comprise at least one point-to-point ethernet bus 110, 112 and/or at least one multi-drop ethernet segment 108A, 108B, 108C. The point-to-point ethernet bus may be, for example, a 100BASE-TX or a 10BASET1L point-to-point ethernet bus. The multi-drop ethernet bus segments may comprise, for example, a 10BASE-T1S multi-drop ethernet bus.

In an example embodiment, the elevator communication system may comprise at least one connecting unit 102A, 102B, 102C comprising a first port connected to the respective multi-drop ethernet bus segments 108A, 108B and a second port connected to the point-to-point ethernet bus 110. Thus, by using the connecting units 102A, 102B, 102C, one or more multi-drop ethernet bus segments 108A, 108B may be connected to the point-to-point ethernet bus 110. The connecting unit 102A, 102B, 102C may refer, for example, to a switch.

The elevator communication system may comprise a point-to-point ethernet bus 112 that provides a connection to an elevator car 114 and to various elements associated with the elevator car 114. The elevator car 114 may comprise a connecting unit 102D, for example, a switch, to which one or more elevator car nodes 116A, 116B, 116C may be connected. In an example embodiment, the elevator car nodes 116A, 116B, 116C, including a camera 116B installed in the elevator car 114, may be connected to the connecting unit 102D via a multi-drop ethernet bus segment 108C, thus constituting an elevator car segment 108C. In an example embodiment, the point-to-point-ethernet bus 112 may be located in the travelling cable of the elevator car 114. In an example embodiment, the camera 116B may be positioned above the car door.

The elevator communication system may further comprise one or more multi-drop ethernet bus segments 108A, 108B (for example, in the form of 10BASE-T1S) reachable by the elevator controller 100, and a plurality of elevator system nodes 104A, 104B, 104C, 106A, 106B, 106C coupled to the multi-drop ethernet bus segments 108A, 108B and configured to communicate via the multi-drop ethernet bus 108A, 108B. The elevator controller 100 is reachable by the elevator system nodes 104A, 104B, 104C, 106A, 106B, 106C via the multi-drop ethernet bus segments 108A, 108B. Elevator system nodes that are coupled to the same multi-drop ethernet bus segment may be configured so that one elevator system node is to be active at a time while the other elevator system nodes of the same multi-drop ethernet bus segment are in a high-impedance state.

In an example embodiment, an elevator system node 104A, 104B, 104C, 106A, 106B, 106C may be configured to interface with at least one of an elevator fixture, an elevator sensor, an elevator safety device, audio means (for example, a microphone and/or a loudspeaker), a camera and an elevator control device. Further, in an example embodiment, power to the nodes may be provided with the same cabling. In another example embodiment, the elevator system nodes 104A, 104B, 104C, 106A, 106B, 106C may comprise shaft nodes, and a plurality of shaft nodes may form a shaft segment, for example, the multi-drop ethernet bus segment 108A, 108B.

At least some of the plurality of elevator system nodes 104A-104C, 106A-106C, 116A-116C each may comprise a camera 104A, 106A associated with different landing floors, respectively, configured to provide image data about a respective landing floor area. The image data may comprise still image data or video data. The camera 104A, 106A may be integrated into a respective landing floor display which is located, for example, above the landing doors. In another embodiment, the camera 104A, 106A may also be integrated into an elevator call device arranged at the landing floor. The plurality of elevator system nodes 104A-104C, 106A-106C, 116A-116C may also comprise a display 116A arranged in the elevator car 114. For example, during a normal elevator use, the display 116A may be used as an infotainment device for passengers. In an evacuation situation, the display 116A may be configured to display data provided by at least one of the cameras 104A, 106A.

In an example embodiment, the elevator communication system may also comprise an apparatus, for example, a server 132 communicatively connected to the controller 100.

FIG. 1B illustrates an elevator communication system according to another example embodiment. The system illustrated in FIG. 1B differs from the system illustrated in FIG. 1A in that a remote node 118 may be communicatively connected to the controller 100. The remote node 118 may be an external node to the elevator communication system, and the controller 100 may be used for providing a connection to the remote node 118. In an evacuation situation, the remote node 118 may be configured to display on a display data provided by at least one of the cameras 104A, 106A, 116B.

FIG. 1C illustrates an elevator communication system according to another example embodiment. The elevator communication system may comprise a controller 100. The elevator communication system further comprises an elevator communication network configured to carry elevator system associated data. The elevator communication network may be an ethernet-based communication network and it may comprise at least one point-to-point ethernet bus and/or at least one multi-drop ethernet segment. The point-to-point ethernet bus may be, for example, a 100BASE-TX or a 10BASET1L point-to-point ethernet bus. The multi-drop ethernet bus segments may comprise, for example, a 10BASE-T1S multi-drop ethernet bus.

In an example embodiment, the elevator communication system may comprise at least one connecting unit 102A, 102B, 102C comprising a first port connected to the respective multi-drop ethernet bus segments 122A, 122B and a second port connected to the point-to-point ethernet bus 110. Thus, by using the connecting units 102A, 102B, 102C, one or more multi-drop ethernet bus segments 122A, 122B may be connected to the point-to-point ethernet bus 110. The connecting unit 102A, 102B, 102C may refer, for example, to a switch.

The elevator communication system may comprise a point-to-point ethernet bus 112 that provides a connection to an elevator car 114 and to various elements associated with the elevator car 114. The elevator car 114 may comprise a connecting unit 102D, for example, a switch, to which one or more elevator car nodes 116A, 116B, 116C may be connected. In an example embodiment, the elevator car nodes 116A, 116B, 116C, including a camera 116B installed in the elevator car 114, may be connected to the connecting unit 102DF via a multi-drop ethernet bus segment 122C, thus constituting an elevator car segment 122C. In an example embodiment, the point-to-point-ethernet bus 112 may be located in the travelling cable of the elevator car 114. In an example embodiment, the camera 116B may be positioned above the car door.

The elevator communication system may further comprise one or more multi-drop ethernet bus segments 122A, 122B, 126A-126C, 130A-130C (for example, in the form of 10BASE-T1S) reachable by the controller 100, and a plurality of elevator system nodes 120A-120F, 124A-124F, 128A-128F coupled to the multi-drop ethernet bus segments 122A, 122B, 126A-126C, 130A-130C and configured to communicate via the multi-drop ethernet bus segments 122A, 122B, 126A-126C, 130A-130C. The controller 100 is reachable by the elevator system nodes 120A-120F, 124A-124F, 128A-128F via the multi-drop ethernet bus segments 122A, 122B, 126A-126C, 130A-130C. Elevator system nodes that are coupled to the same multi-drop ethernet bus segment may be configured so that one elevator system node is to be active at a time while the other elevator system nodes of the same multi-drop ethernet bus segment are in a high-impedance state.

In an example embodiment, an elevator system node 116A-116C, 124A-124F, 130A-130F may be configured to interface with at least one of an elevator fixture, an elevator sensor, an elevator safety device, audio means (for example, a microphone and/or a loudspeaker), a camera and an elevator control device. Further, in an example embodiment, power to the nodes may be provided with the same cabling. In another example embodiment, the elevator system nodes 120A-120F may comprise shaft nodes, and a plurality of shaft nodes may form a shaft segment, for example, the multi-drop ethernet bus segment 122A, 122B.

At least some of the plurality of elevator system nodes 116A-116C, 124A-124F, 128A-128F each may comprise a camera 124A, 124C, 124E, 128A, 128C, 128E associated with different landing floors, respectively, configured to provide image data about a respective landing floor area. The camera 124A, 124C, 124E, 128A, 128C, 128E may be integrated into a respective landing floor display which is located, for example, above the landing doors. The camera 124A, 124C, 124E, 128A, 128C, 128E may also be integrated into an elevator call device arranged at the landing floor. The plurality of elevator system nodes 116A-116C, 124A-124F, 128A-128F may also comprise a display 116A arranged in the elevator car 114. For example, during a normal elevator use, the display 116A may be used as an infotainment device for passengers. In an evacuation situation, the display 116A may be configured to display data provided by at least one of the cameras 124A, 124C, 124E, 128A, 128C, 128E.

By implementing communication within the elevator communication system using at least one point-to-point ethernet bus and at least one multi-drop ethernet bus segment, various segments can be formed within the elevator communication system. For example, the elevator system nodes 124A-124B may form a first landing segment 126A, the elevator system nodes 124C-124D may form a second landing segment 126B, the elevator system nodes 124E-124F may form a third landing segment 126C, the shaft nodes 120A-120C may form a first shaft segment 122A, the shaft nodes 120D-120F may form a second shaft segment 122B, and the elevator car nodes 116A-116C may form an elevator car segment 122C. Each of the segments 122A-122C, 126A-126C may be implemented using separate multi-drop ethernet buses.

As illustrated in FIG. 1C, the shaft nodes 120A-120F interconnect the shaft segments 122A, 122B to which the shaft nodes 124A-124F, 128A-128F are connected to and the landing segments 126A-126C. In other words, the shaft nodes 120A-120C may comprise or may act as a switch to the landing segments 126A-126C, 130A-130C. This may enable a simple solution for adding new elevator system nodes to the elevator communication system. This may also enable a solution in which a single elevator system node may act as a switch or a repeater to another multi-drop ethernet bus segment to which nearby elevator system elements, for example, a call button or buttons, a display or displays, a destination operating panel or panels, a camera or cameras, a voice intercom device etc. may be connected.

FIG. 1D illustrates an elevator communication system according to another example embodiment. The system illustrated in FIG. 1D differs from the system illustrated in FIG. 1C in that a remote node 118 may be communicatively connected to the controller 100. The remote node 118 may be an external node to the elevator communication system, and the controller 100 may be used for providing a connection to the remote node 118. In an evacuation situation, the remote node 118 may be configured to display on a display data provided by at least one of the cameras 116B, 124A, 124D, 124G, 128A, 128D, 128G.

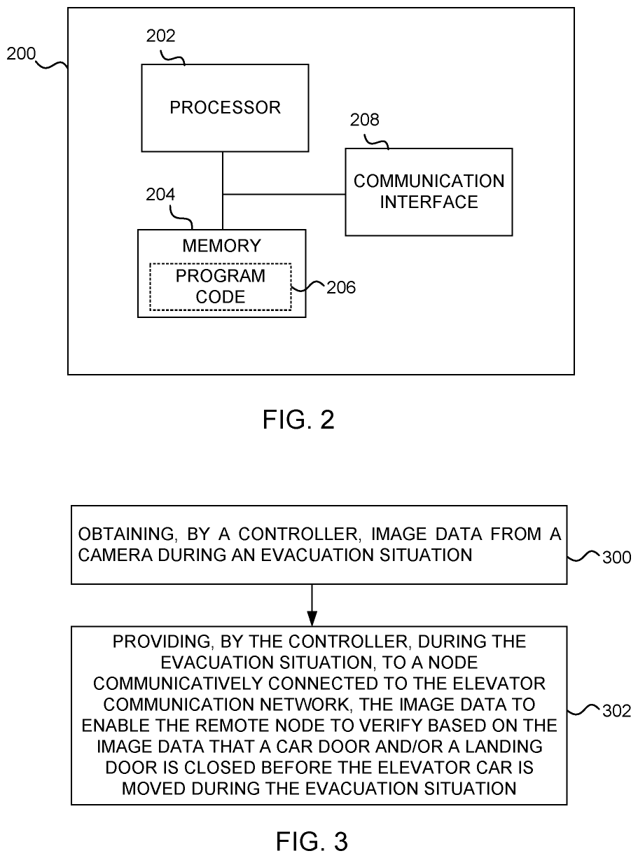

FIG. 2 illustrates an apparatus 200 associated with an elevator communication system according to an embodiment. The apparatus 200 may comprise at least one processor 202. The apparatus 200 may further comprise at least one memory 204. The memory 204 may comprise program code 206 which, when executed by the processor 202 causes the apparatus 200 to perform at least one example embodiment. The exemplary embodiments and aspects of the subject-matter can be included within any suitable device, for example, including, servers, elevator controllers, workstations, capable of performing the processes of the exemplary embodiments. The exemplary embodiments may also store information relating to various processes described herein. Although the apparatus 200 is illustrated as a single device it is appreciated that, wherever applicable, functions of the apparatus 200 may be distributed to a plurality of devices.

Example embodiments may be implemented in software, hardware, application logic or a combination of software, hardware and application logic. The example embodiments can store information relating to various methods described herein. This information can be stored in one or more memories 204, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

The processor 202 may comprise one or more general purpose processors, microprocessors, digital signal processors, micro-controllers, and the like, programmed according to the teachings of the example embodiments, as will be appreciated by those skilled in the computer and/or software art(s). Appropriate software can be readily prepared by programmers of ordinary skill based on the teachings of the example embodiments, as will be appreciated by those skilled in the software art. In addition, the example embodiments may be implemented by the preparation of application-specific integrated circuits or by interconnecting an appropriate network of conventional component circuits, as will be appreciated by those skilled in the electrical art(s). Thus, the examples are not limited to any specific combination of hardware and/or software. Stored on any one or on a combination of computer readable media, the examples can include software for controlling the components of the example embodiments, for driving the components of the example embodiments, for enabling the components of the example embodiments to interact with a human user, and the like. Such computer readable media further can include a computer program for performing all or a portion (if processing is distributed) of the processing performed in implementing the example embodiments. Computer code devices of the examples may include any suitable interpretable or executable code mechanism, including but not limited to scripts, interpretable programs, dynamic link libraries (DLLs), Java classes and applets, complete executable programs, and the like.

As stated above, the components of the example embodiments may include computer readable medium or memories 204 for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

The apparatus 200 may comprise a communication interface 208 configured to enable the apparatus 200 to transmit and/or receive information, to/from other apparatuses.

The apparatus 200 comprises means for performing at least one method described herein. In one example, the means may comprise the at least one processor 202, the at least one memory 204 including program code 206 configured to, when executed by the at least one processor 202, cause the apparatus 200 to perform the method.

FIG. 3 illustrates a method according to an example embodiment. The method may be performed, for example, in an elevator communication system illustrated in any of FIGS. 1A-1D.

At 300, image data is obtained by an apparatus, for example, the controller 100 or the server 132, connected to an elevator communication network during an evacuation situation from the camera 104A, 106A, 116B, 124A, 124C, 124E, 128A, 128C, 128E, the camera being communicatively connected to the elevator communication network and associated with at least one of the elevator car 114 configured to provide image data indicating whether a car door of the elevator car 114 is open or closed and a landing floor configured to provide image data indicating whether a landing door of the landing floor is open or closed.

At 302 the image data is provided by the apparatus 200 during the evacuation situation to the node 116A, 118 communicatively connected to the elevator communication network to enable the node 116A, 118 to verify based on the image data that the car door and/or the landing door is closed before the elevator car 114 is moved during the evacuation situation.

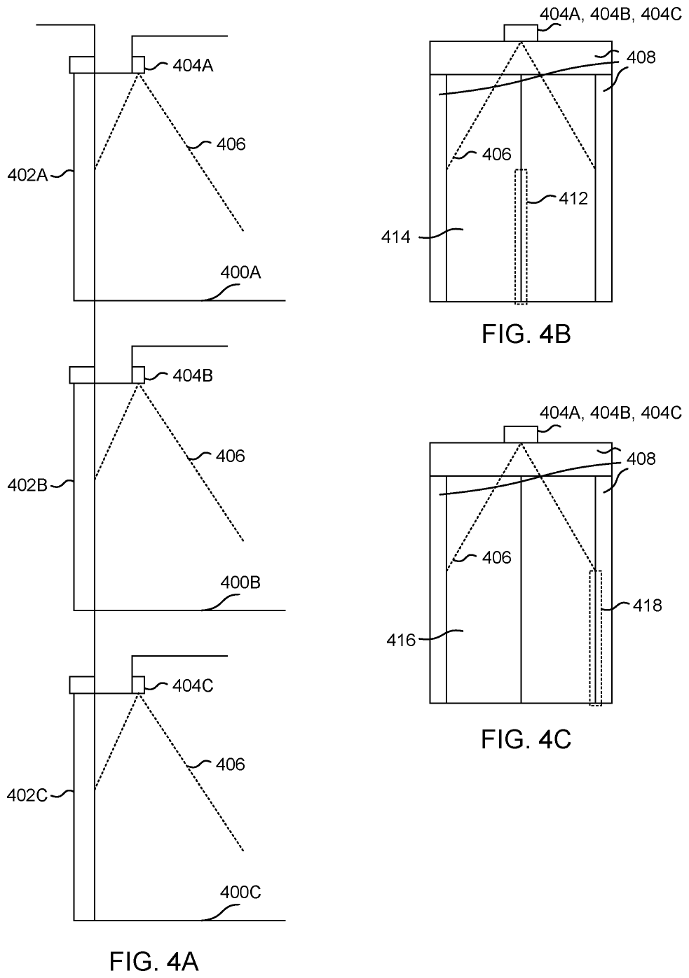

FIG. 4A illustrates landing floors 400A-400C where a camera 404A, 404B, 404C has been arranged above a door frame 408. In the embodiment illustrated in FIG. 4A, the camera 404A, 404B, 404C has been arranged or integrated into a landing floor display that is typically placed above landing doors 402A, 402B, 402C. The camera 404A, 402B, 402C may be positioned so that its viewing angle/recording angle 406 at least partially covers the landing doors 402A, 402B, 402C.

FIGS. 4B and 4C illustrate the setup of FIG. 4A from a different viewing angle. FIG. 4B illustrated an embodiment in which a landing door 414 comprises two door leaves opening from the middle to opposite directions. FIG. 4C illustrates an embodiment in which the landing door 416 opens from one side of the door frame. The dashed line section 412 illustrates a section of the landing door 414 covered by the camera 404A, 404B, 404C. If the door leaves of the landing door 414 are contacting each other based in the image provided by the camera 404A, 404B, 404C, the landing door 414 can be interpreted to be in a closed state. If, on the other hand, the image provided by the camera 404A, 404B, 404C shows that the door leaves are not next to each other, the landing door 414 is in an open state for some reason. Similarly, the dashed line section 418 illustrates a section of the landing door 416 covered by the camera 404A, 404B, 404C. If a door leaf of the landing door 414 is contacting the door frame 408 in the image provided by the camera 404A, 404B, 404C, the landing door 416 can be interpreted to be in a closed state. If, on the other hand, the image provided by the camera 404A, 404B, 404C shows that there is a gap between the door leaf and the door frame 408, the landing door 418 is in an open state for some reason.

The camera 404A, 404B, 404C may be positioned so that at least a portion, for example, at least a bottom part of the landing door 414, 416 is covered by the camera 404A, 404B, 404C. This makes it possible to determine based on image data provided by the camera 404A, 404B, 404C whether the landing door 414, 416 is open or closed.

In an example embodiment, a similar arrangement may be arranged in the elevator car 114. There, the camera 116B may be positioned above the car doors so that at least a portion, for example, at least a bottom part of the car door is covered by the camera 116B. This makes it possible to determine based on image data provided by the camera 116B whether the car door is open or closed.

In an example embodiment, the image data may comprise a time stamp enabling verification of the validity of the image data at the node 116A, 118. In other words, the node 118 or an operator at the node 118 may compare the time stamp in the image data to the current time. If the time stamp essentially matches with the current time, it can determined that the image data is valid. In another example embodiment, at least some of the plurality of elevator system nodes 104A-104C, 106A-106C, 116A-116C, 124A-124F, 128A-128F each may comprise a floor control board associated with the landing floor configured to provide floor information to be associated with the image data. In other words, the floor control board may store a verified floor number and the floor control board may be configured to provide the floor number to the camera 104A, 106A, 116B, 124A, 124C, 124E, 128A, 128C, 128E, 404A, 404B, 404C, and the camera 104A, 106A, 116B, 124A, 124C, 124E, 128A, 128C, 128E, 404A, 404B, 404C may be configured to integrate the floor number to the image data.

Further, in an example embodiment, the controller 100 or the server 132 may be configured to receive a verification request from the node 118 to distinguish the elevator car 114 among a plurality of elevators cars. For example, a building may comprises several elevator shafts and thus several elevator cars, and there may be need to seek confirmation that the image data comes from a specific elevator car and that the image data is recent/valid. In response to the verification request, the controller 100 or the server 132 may be configured to cause generation of a response action. The response action may be, for example, a visual signal that originates from the elevator car. If the same visual signal is then identified in the image signal from the camera 116B in the elevator car 114, it can be determined that the image data is recent/valid. A similar visual signal may be applied also in the case of landing floor cameras. For example, lights in a landing floor may be temporarily changed so that the change can be seen also in image data provided by a camera in the landing floors. This provides a verification that the image data provided by the camera is recent/valid.

At least some of the above discussed example embodiments may enable transmission of any device data seamlessly between elevator system devices and any other device or system. Further, a common protocol stack may be used for all communication. Further, at least some of the above discussed example embodiments may enable a solution in which an operator in a rescue situation is able to ensure that the car door and/or the landing door or doors are closed before moving the elevator car, for example, by releasing car brakes.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. An elevator communication system, comprising:
an elevator communication network configured to carry elevator system associated data;
a plurality of elevator system nodes communicatively connected to the elevator communication network, wherein at least some of the plurality of elevator system nodes each comprises a camera associated with at least one of an elevator car configured to provide image data indicating whether a car door of the elevator car is open or closed and a landing floor configured to provide image data indicating whether a landing door of the landing floor is open or closed;
an elevator car; and
an apparatus communicatively connected to the elevator communication network and being configured to:
obtain image data from the camera during an evacuation situation; and
provide, during the evacuation situation, to a node communicatively connected to the elevator communication network, the image data to enable the node to verify based on the image data that the car door and/or the landing door is closed before the elevator car is moved during the evacuation situation.

2. The elevator communication system of claim 1, wherein the image data provided by the camera at least partially covers the car door or the landing door.

3. The elevator communication system of claim 1, wherein the camera is integrated into a landing floor display.

4. The elevator communication system of claim 1, wherein the camera is positioned above the car door.

5. The elevator communication system of claim 1, wherein the image data comprises a time stamp enabling verification of the validity of the image data at the node.

6. The elevator communication system of claim 1, wherein the plurality of elevator system nodes comprise a floor control board associated with the landing floor configured to provide floor information to be associated with the image data.

7. The elevator communication system of claim 1, wherein the apparatus is configured to:
receive a verification request from the node to distinguish the elevator car among a plurality of elevators cars; and
cause generation of a response action in response to the verification request.

8. The elevator communication system of claim 1, wherein the node comprises a node internal to the elevator communication system.

9. The elevator communication system of claim 8, wherein the node comprises a display arranged in an elevator car.

10. The elevator communication system of claim 1, wherein the node comprises a remote node external to the elevator communication system.

11. The elevator communication system of claim 1, wherein the elevator communication network comprises at least one point-to-point ethernet network.

12. The elevator communication system of claim 1, wherein the elevator communication network comprises at least one multi-drop ethernet segment.

13. A method comprising:
obtaining, by an apparatus connected to an elevator communication network, image data during an evacuation situation from a camera being communicatively connected to the elevator communication network and associated with at least one of an elevator car configured to provide image data indicating whether a car door of the elevator car is open or closed and a landing floor configured to provide image data indicating whether a landing door of the landing floor is open or closed; and
providing, by the apparatus, during the evacuation situation to a node communicatively connected to the elevator communication network the image data to enable the node to verify based on the image data that the car door and/or the landing door is closed before the elevator car is moved during the evacuation situation.

14. The method of claim 13, wherein the image data provided by the camera at least partially covers the car door or the landing door.

15. The method of claim 13, wherein the camera is integrated into a landing floor display.

16. The method of claim 13, wherein the camera is positioned above the car door.

17. The method of claim 13, wherein the image data comprises a time stamp enabling verification of the validity of the image data at the node.

18. The method of claim 13, wherein the plurality of elevator system nodes comprise a floor control board associated with the landing floor configured to provide floor information to be associated with the image data.

19. The method of claim 13, further comprising:
receiving, by the apparatus, a verification request from the node to distinguish the elevator car among a plurality of elevators cars; and
causing, by the apparatus, generation of a response action in response to the verification request.

20. The method of claim 13, wherein the node comprises a node internal to the elevator communication system.

21. The method of claim 20, wherein the node comprises a display arranged in an elevator car.

22. The method of claim 13, wherein the node comprises a remote node external to the elevator communication system.

23. The method of claim 13, wherein the elevator communication network comprises at least one point-to-point ethernet network.

24. The method of claim 13, wherein the elevator communication network comprises at least one multi-drop ethernet segment.

25. An elevator system comprising the elevator communication system of claim 1.

26. An apparatus connected to an elevator communication network, the apparatus comprising:
means for obtaining image data during an evacuation situation from a camera being communicatively connected to the elevator communication network and associated with at least one of an elevator car configured to provide image data indicating whether a car door of the elevator car is open or closed and a landing floor configured to provide image data indicating whether a landing door of the landing floor is open or closed; and
means for providing during the evacuation situation to a node communicatively connected to the elevator communication network the image data to enable the node to verify based on the image data that the car door and/or the landing door is closed before the elevator car is moved during the evacuation situation.
